(19) United States
(12) Patent Application Publication
(10) Pub. No.: US 2007/0220511 A1
(43) Pub. Date: Sep. 20, 2007

(54) Ensuring a stable application debugging environment via a unique hashcode identifier

(76) Inventors: James C. Clarke, Apex, NC (US); Drew A. Douglass, Raleigh, NC (US); James E. Fox, Apex, NC (US); Ricky L. Marley, Elon, NC (US)

Correspondence Address: DILLON & YUDELL LLP, 8911 N. CAPITAL OF TEXAS HWY., SUITE 2110, AUSTIN, TX, 78759, US

(21) Appl. No.: 11/375,887

(22) Filed: Mar. 15, 2006

(51) Int. Cl. G06F 9/445

(52) U.S. Cl. 717/174

(57) ABSTRACT

A method and system for ensuring a stable application debugging environment via a unique hash code identifier is presented. The method includes the steps of appending a first timestamp to a first software file that is located in a client system, wherein the first timestamp indicates when the first software file was last modified; and comparing the first timestamp with a latest authorized first timestamp for the first software file.

### BACKGROUND OF THE INVENTION

The present invention relates in general to the field of computers and similar technologies, and in particular to software utilized in this field.

In large application deployments, oftentimes a customer will have long-running issues that require the testing of fixes and an understanding of what changes have been made over the course of debugging. Problems occur when customers have large, distributed environments and may be constantly inserting seemingly “irrelevant” code changes or patches from disjointed groups into an application. For example, consider a case in which a customer is using Commerce Suite™, an application that runs on WebSphere®, which is integration and application infrastructure software from International Business Machines (IBM) Corporation. WebSphere® provides an environment for a customer to utilize, create, manage and maintain applications. A fix that is needed in WebSphere® may be sent to a customer. Alternatively, the customer may insert (drop) a fix into his WebSphere application server. As a result, because Commerce Suite™ runs on top of WebSphere®, the changes that are made to WebSphere® may affect the Commerce Suite™ application. In the case where the Commerce Suite™ application is administered separately from the other applications on the WebSphere® application server, an administration team for Commerce Suite™ may not be aware of the changes made to the base WebSphere® Application server. If a new runtime issue arises in the Commerce Suite™ application, the Commerce Suite™ administration team may not understand or know of the delta that occurred on the base application server, and will not know to either address or inform the product support team of such changes. A similar scenario occurs when a customer makes his own changes to Commerce Suite™ (either authorized or more commonly, unauthorized) without the WebSphere® administrator's knowledge. In either scenario, unnecessary delays in debugging the customer's issues occur.

### SUMMARY OF THE INVENTION

To address the problem described above, an improved method, apparatus and computer-readable medium is presented for ensuring a stable application debugging environment via a unique hash code identifier. In one embodiment, the method includes the steps of appending a first timestamp to a first software file that is located in a client system, wherein the first timestamp indicates when the first software file was last modified; and comparing the first timestamp with a latest authorized first timestamp for the first software file.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 illustrates a chart of files, timestamps and hashes in a server such as a WebSphere® server;

FIG. 2a depicts a chart of files, timestamps and hash in a client that is served by the WebSphere® server whose files are shown in FIG. 1;

FIG. 2b illustrates the files, timestamps and hashes in the client if the customer changes an application;

FIG. 2c illustrates the files, timestamps and hashes in the client if the customer changes a configuration file;

FIG. 3 is a flow-chart of exemplary steps taken in an embodiment of the present invention;

FIG. 4 depicts an exemplary client computer in which the present invention may implemented;

FIG. 5 illustrates an exemplary server from which software for executing the present invention may be deployed and/or implemented for the benefit of a user of the client computer shown in FIG. 4;

FIGS. 6a-b show a flow-chart of steps taken to deploy software capable of executing the steps shown and described in FIGS. 1-3;

FIGS. 7a-c show a flow-chart of steps taken to deploy in a Virtual Private Network (VPN) software that is capable of executing the steps shown and described in FIGS. 1-3;

FIGS. 8a-b show a flow-chart showing steps taken to integrate into a computer system software that is capable of executing the steps shown and described in FIGS. 1-3; and

FIGS. 9a-b show a flow-chart showing steps taken to execute the steps shown and described in FIGS. 1-3 using an on-demand service provider.

### DETAILED DESCRIPTION OF THE PREFERRED EMBODIMENT

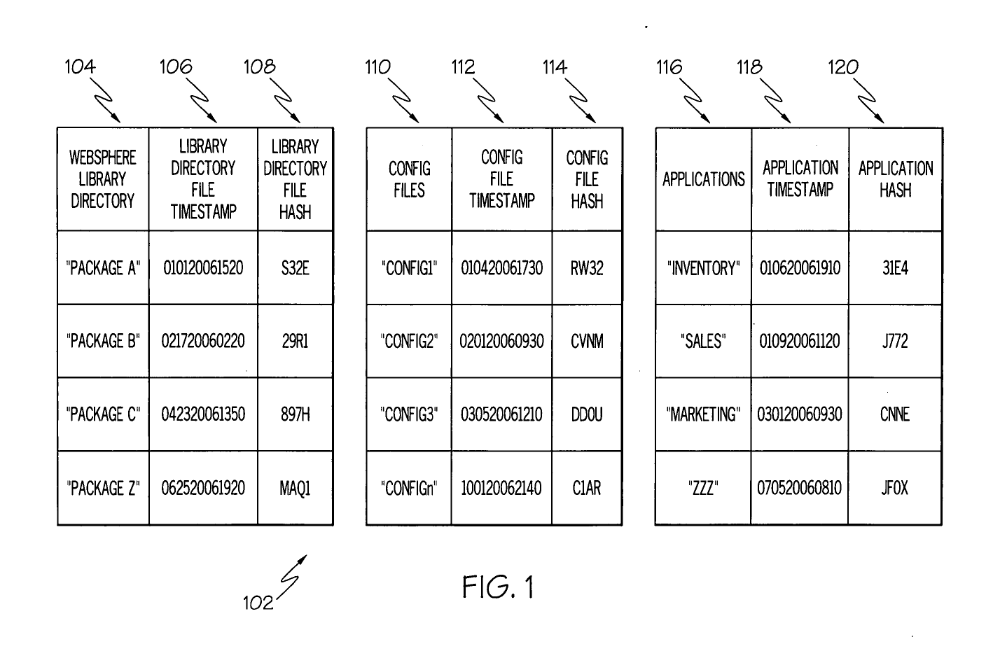

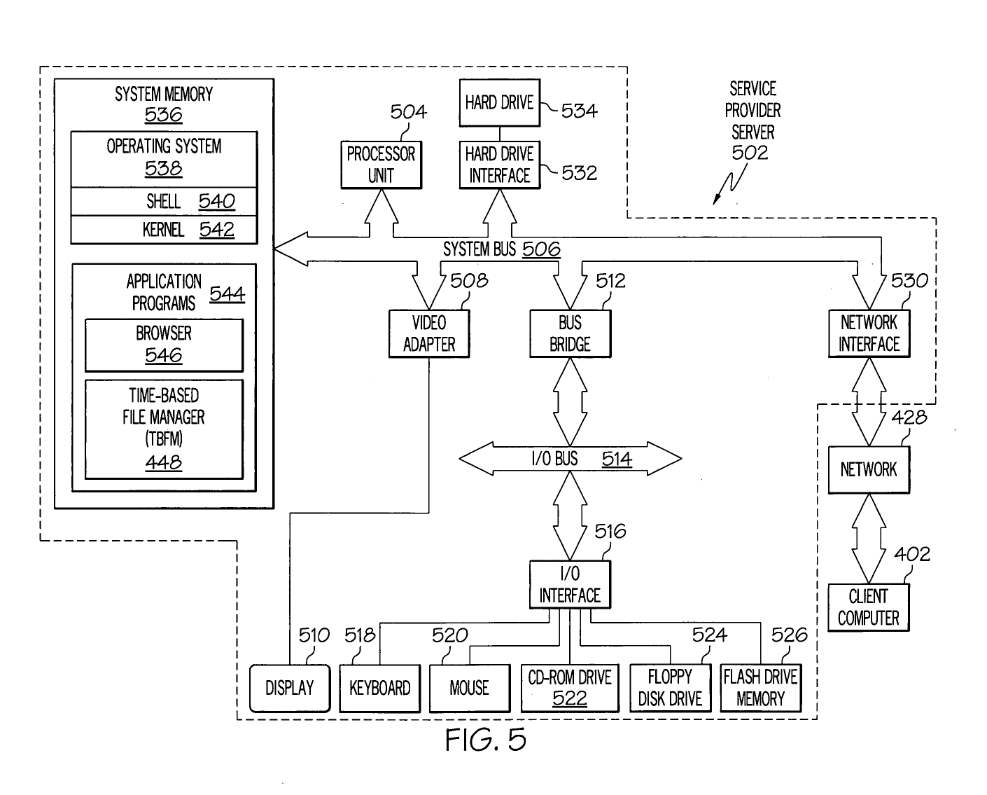

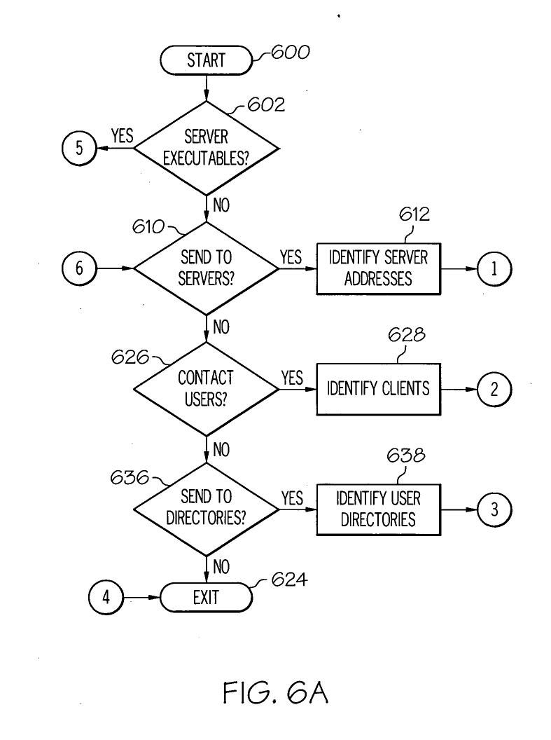

With reference now to the figures, and in particular to FIG. 1, a presentation is made of a table 102, which is available to (and preferably stored within) a service provider server such as a WebSphere® server (shown in an exemplary manner below in FIG. 5 as Service Provider Server 502). Table 102 includes a library directory 104, a set of corresponding library directory file timestamps 106, and a set of corresponding library directory file hashes 108. Note that the library files name and describe a system configuration and application packages that are available from the WebSphere® application infrastructure. For example, the file named “Package A” in library directory 104 may provide a client system with a configuration setup described by “Config2” along with one or more application files (such as “Sales” and “Marketing”). As the corresponding entry in library directory file timestamps 106 indicates, Package A was last amended (or else initially installed) on Jan. 1, 2006 at 1520 hours (“010120061520”). This time stamp is shown at an exemplary granularity, and of course may be adjusted to any granularity (e.g., day, hour, minute, second, partial second, etc.) desired. When the timestamp “010120061520” is appended to the name “Package A” and then hashed, “S32E” is the resulting hash. As understood by those skilled in the art, hashing essentially involves inputting one or more inputs (e.g., “010120061520” and the ASCII characters “Package A”) into a hashing algorithm, which outputs a non-reversible value (e.g., “S32E”) that is called a “hash.” Alternatively, the inputs can be the timestamp plus a simple flag or register that contains pre-defined value for the package. Hashing processes described below for configurations and applications can likewise use flags and/or registers as the values to which the timestamp is appended for hashing.

Similarly, table 102 includes configuration files 110, corresponding configuration file timestamps 112, and their corresponding configuration file hashes 114. Note that the configuration files describe how the WebSphere® application infrastructure is configured for a client's system. Likewise, table 102 includes a list of applications 116 that are available from a WebSphere® server, as well as those applications' timestamps 118 and their resulting (hashing of appended timestamps to application names) hashes 120.

Note that configuration file named “Config1” may or may not correspond with the WebSphere® library file “Program A,” just as application “Inventory” may or may not correspond with “Config1” and/or “Program A.” That is, “Program A” includes (typically) a single configuration file and one or more application files that are to be used by a client in the client's computer. Thus, it should not be assumed that, because “Program A” and “Config1” and “Inventory” are in a same row of Table 102 that “Config1” and “Inventory” are part of (exclusively or non-exclusively) “Program A,” nor should it be assumed that “Config1” and “Inventory” are not part of “Program A.”

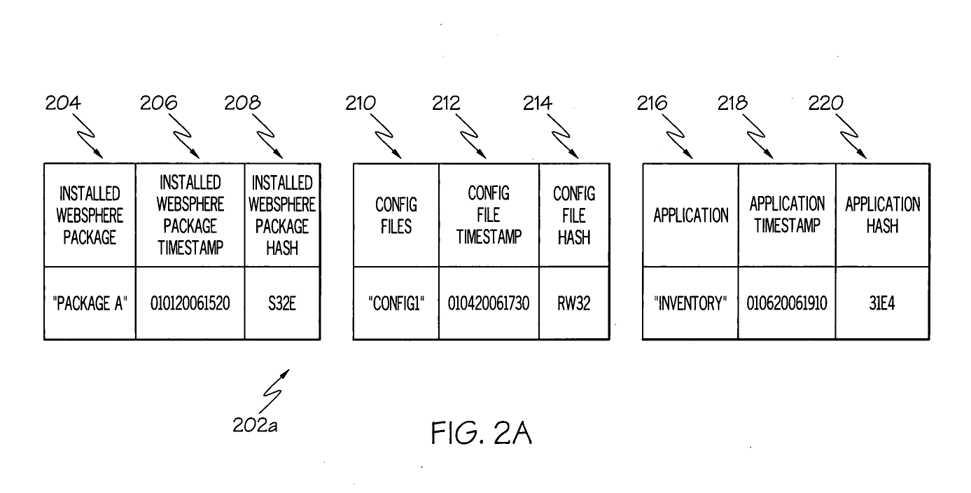

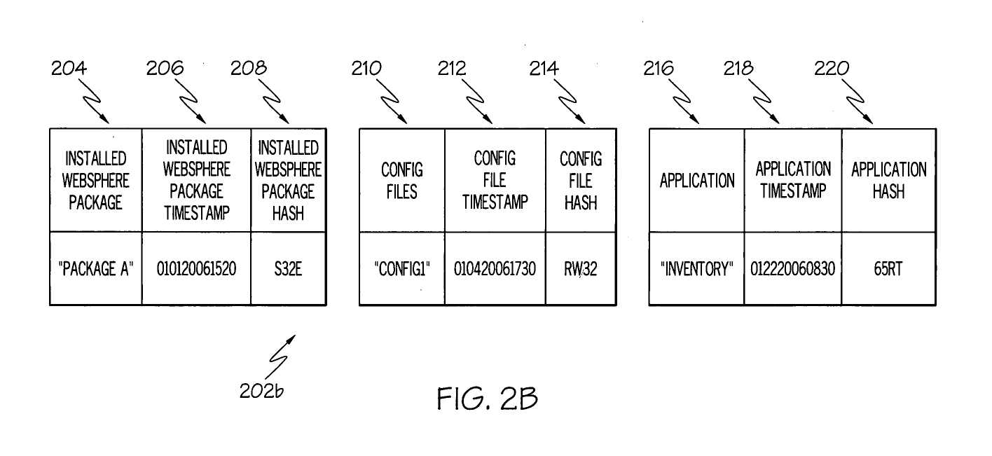

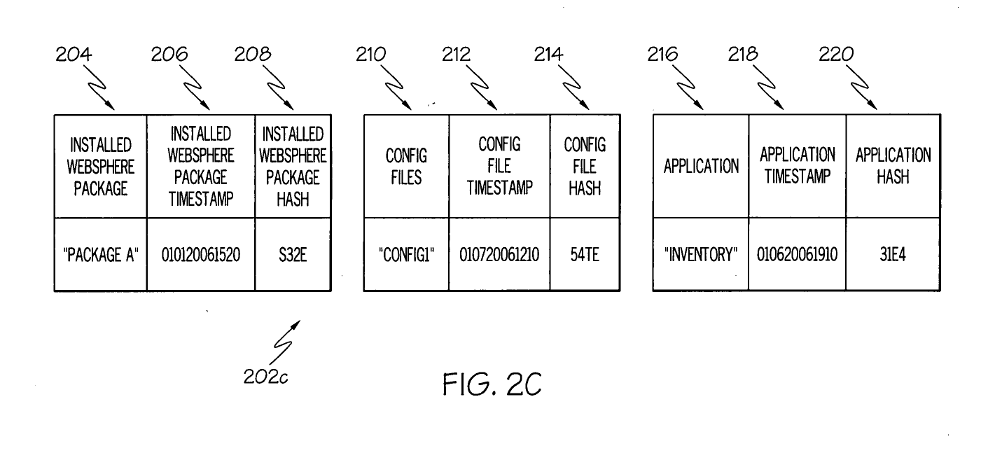

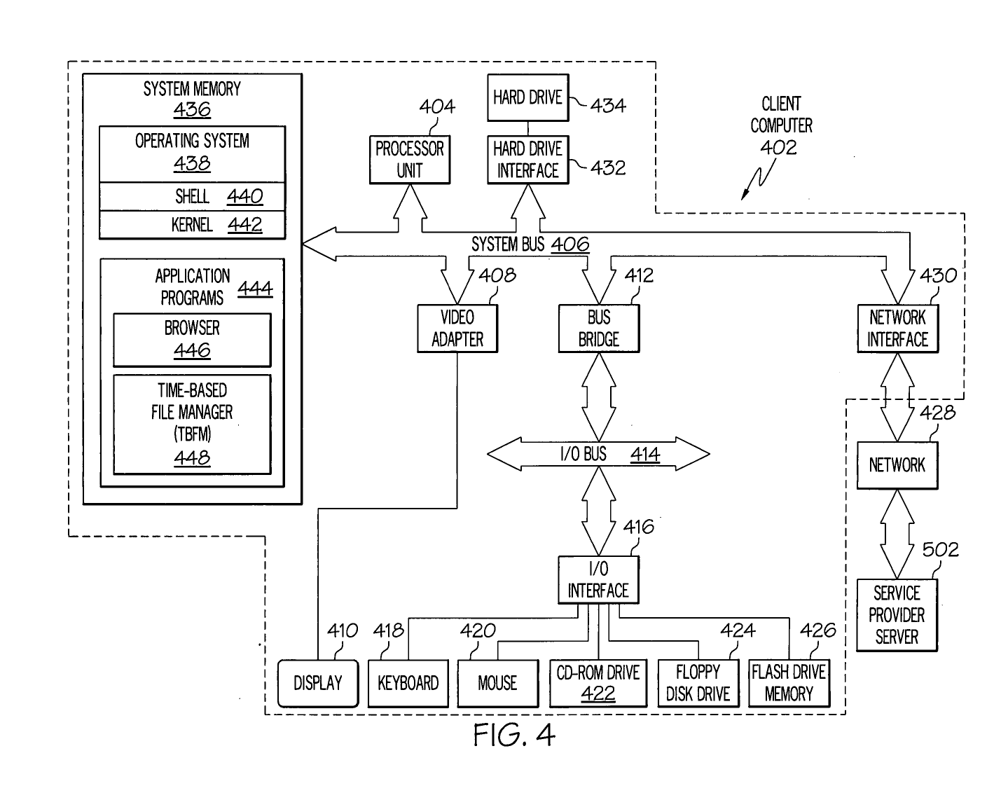

With reference now to FIG. 2a, a table 202a depicts files that are accessible to (and preferably stored within) a client system, such as shown below in an exemplary manner as Client Computer 402 in FIG. 4. As depicted, the client system is using a WebSphere® package 204 named “Package A,” which was last installed (or modified) on Jan. 1, 2006 at 1520 hours (as indicated by the value “010120061520” shown in installed WebSphere® package timestamp 206. When “010120061520” is appended to the ASCII characters “Package A” and then hashed, the installed WebSphere® package hash 208 is “S32E,” thus indicating that the client and the WebSphere® server have the same version and timestamp of “Package A” (as shown in the corresponding library directory hash file 108 shown for the server in FIG. 1). Similarly, the contents (or values) of configuration file timestamp 212 configuration file hash 214 are the same for the configuration file 210 (named “Config1”) as found in table 102 under configuration files 110, and the contents (or values) of application timestamp 218 and application hash 220 are the same for the application file 116 (named “Inventory”) as found in table 102. Thus, the WebSphere® administrator can be assured that both the WebSphere® server and the client system have the same time-stamped versions of the WebSphere® package, configuration and application(s).

Referring now to FIG. 2b, note that table 202b has a different timestamp for application time stamp 218 (“010620061910” has been changed to “012220060830”), and thus a different application hash 220 (which has changed from “31E4” to “65RT”). Thus, it can be concluded that the client has made a change (either authorized or unauthorized) to the application named “Inventory,” at a time that is different from that time at which “Inventory” was last updated in the WebSphere® server.

Similarly, as shown in table 202c of FIG. 2c, configuration file 210 named “Config1” has a different time stamp (“010720061210”) from the time stamp held in the WebSphere® server (“010420061730”), and thus configuration file hash 214 is different (“54TE” instead of “RW32”). Note that package names, configuration files and application names are used for exemplary purposes in one embodiment of the present invention, and the same concept may be used by any process in which server and client files are compared as described herein.

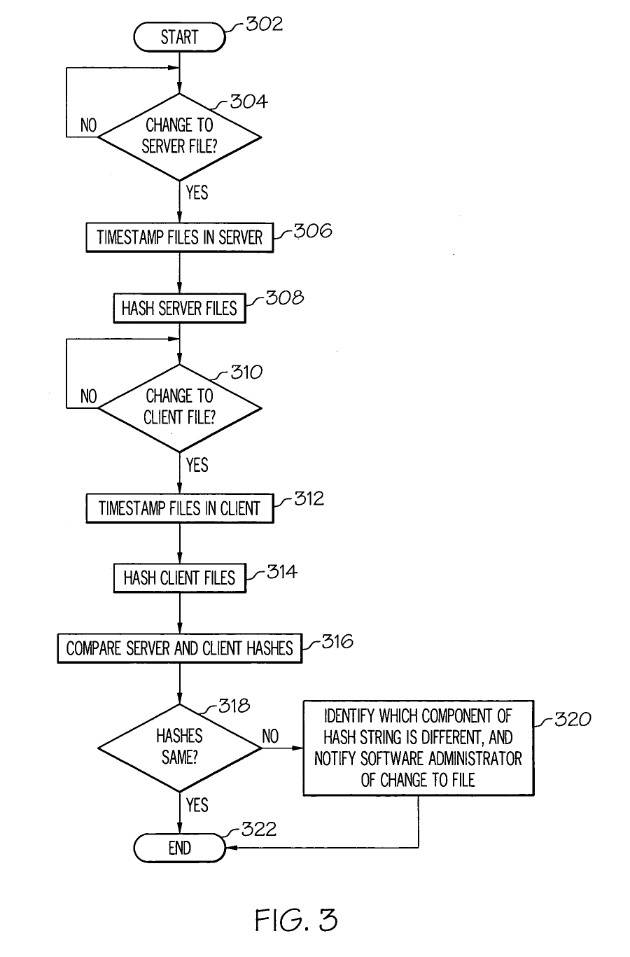

Referring now to FIG. 3, a flow-chart of exemplary steps taken by the present invention. After initiator block 302, a query is made as to whether there has been a change made (either an installation of or a modification to) in a server file (query block 304). If so, then a timestamp of when the installation or modification is made is appended to the installed/modified file (block 306), and a hash is created (block 308). Note that in one embodiment of the invention, each iteration of blocks 304 to 308 creates a manifest of all of the files in their respective directories and their respective timestamps and hashes. In an exemplary manner, a 4-digit hash code is then generated from this manifest, and is appended in the following order:
libraries+“”+configFiles+“”+application1+“”application2+. . .
This results in a systemout log, which is preferably generated at trigger points such as startup, restart, when saving configuration changes, etc., which, assuming that only one application is being installed in the client system, would look like:
WAS_ID_CODE=S32E RW32 31E4
for a WebSphere® Application Server (WAS) having hash values shown in FIG. 1 for “Package A” (hash “S32E”), “config1” (hash “RW32”) and application “Inventory” (hash “31E4”).

Returning to FIG. 3, a query is then made regarding any changes to the client files (query block 310). If a change has been made to a client file, then a new timestamp is generated reflecting when the change was made (block 312), and a new hash is generated by appending the new timestamp with the file name (or register value), as described in block 314. The server and client has values are then compared (block 316). For example, if the client (customer) has changed the application named “Inventory,” then the systemout log line would print out as:
WAS_ID_CODE=S32E RW32 65RT
Similarly, if the change was at the configuration level (e.g., Java Virtual Machine (JVM) parameters, etc.), then the line would read:
WAS_ID_CODE=S32E 54TE 31E4

Thus, if any part of the string of hash codes are different (query block 318), then, upon identifying which part of the string is different, the WebSphere® is so notified (block 320), providing valuable information for detecting unauthorized changes, piracy, etc. to the packages, and/or for providing valuable information used in debugging problems with the client's system. The process thus ends at terminator block 322, or may repeat in an iterative fashion at any point in the flowchart.

With reference now to FIG. 4, there is depicted a block diagram of an exemplary client computer 402, in which the present invention may be utilized. Client computer 402 includes a processor unit 404 that is coupled to a system bus 406. A video adapter 408, which drives/supports a display 410, is also coupled to system bus 406. System bus 406 is coupled via a bus bridge 412 to an Input/Output (I/O) bus 414. An I/O interface 416 is coupled to I/O bus 414. I/O interface 416 affords communication with various I/O devices, including a keyboard 418, a mouse 420, a Compact Disk—Read Only Memory (CD-ROM) drive 422, a floppy disk drive 424, and a flash drive memory 426. The format of the ports connected to I/O interface 416 may be any known to those skilled in the art of computer architecture, including but not limited to Universal Serial Bus (USB) ports.

Client computer 402 is able to communicate with a service provider server 502 via a network 428 using a network interface 430, which is coupled to system bus 406. Network 428 may be an external network such as the Internet, or an internal network such as an Ethernet or a Virtual Private Network (VPN). Using network 428, client computer 402 is able to use the present invention to access service provider server 502.

A hard drive interface 432 is also coupled to system bus 406. Hard drive interface 432 interfaces with a hard drive 434. In a preferred embodiment, hard drive 434 populates a system memory 436, which is also coupled to system bus 406. Data that populates system memory 436 includes client computer 402's operating system (OS) 438 and application programs 444.

OS 438 includes a shell 440, for providing transparent user access to resources such as application programs 444. Generally, shell 440 is a program that provides an interpreter and an interface between the user and the operating system. More specifically, shell 440 executes commands that are entered into a command line user interface or from a file. Thus, shell 440 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 442) for processing. Note that while shell 440 is a text-based, line-oriented user interface, the present invention will equally well support other user interface modes, such as graphical, voice, gestural, etc.

As depicted, OS 438 also includes kernel 442, which includes lower levels of functionality for OS 438, including providing essential services required by other parts of OS 438 and application programs 444, including memory management, process and task management, disk management, and mouse and keyboard management.

Application programs 444 include a browser 446. Browser 446 includes program modules and instructions enabling a World Wide Web (WWW) client (i.e., client computer 402) to send and receive network messages to the Internet using HyperText Transfer Protocol (HTTP) messaging, thus enabling communication with service provider server 502.

Application programs 444 in client computer 402's system memory also include a Time-Based File Manager (TBFM) 448. TBFM 448 includes code for implementing the processes described in FIGS. 1-3, and includes the data structure represented in exemplary fashion in FIGS. 2a-c. In one embodiment, client computer 402 is able to download TBFM 448 from service provider server 502.

The hardware elements depicted in client computer 402 are not intended to be exhaustive, but rather are representative to highlight essential components required by the present invention. For instance, client computer 402 may include alternate memory storage devices such as magnetic cassettes, Digital Versatile Disks (DVDs), Bernoulli cartridges, and the like. These and other variations are intended to be within the spirit and scope of the present invention.

As noted above, TBFM 448 can be downloaded to client computer 502 from service provider server 502, shown in exemplary form in FIG. 5. Service provider server 502 includes a processor unit 504 that is coupled to a system bus 506. A video adapter 508 is also coupled to system bus 506. Video adapter 508 drives/supports a display 510. System bus 506 is coupled via a bus bridge 512 to an Input/Output (I/O) bus 514. An I/O interface 516 is coupled to I/O bus 514. I/O interface 516 affords communication with various I/O devices, including a keyboard 518, a mouse 520, a Compact Disk—Read Only Memory (CD-ROM) drive 522, a floppy disk drive 524, and a flash drive memory 526. The format of the ports connected to I/O interface 516 may be any known to those skilled in the art of computer architecture, including but not limited to Universal Serial Bus (USB) ports.

Service provider server 502 is able to communicate with client computer 402 via network 428 using a network interface 530, which is coupled to system bus 506. Access to network 428 allows service provider server 502 to execute and/or download TBFM 448 to client computer 402.

System bus 506 is also coupled to a hard drive interface 532, which interfaces with a hard drive 534. In a preferred embodiment, hard drive 534 populates a system memory 536, which is also coupled to system bus 506. Data that populates system memory 536 includes service provider server 502's operating system 538, which includes a shell 540 and a kernel 542. Shell 540 is incorporated in a higher level operating system layer and utilized for providing transparent user access to resources such as application programs 544, which include a browser 546, and a copy of TBFM 448 described above, which can be deployed to client computer 402. Note that when residing within service provider server 502, TBFM 448 includes TBFM 448 includes the data structure represented in exemplary fashion in FIG. 1, and optionally also includes the data represented in exemplary fashion FIGS. 2a-c.

The hardware elements depicted in service provider server 502 are not intended to be exhaustive, but rather are representative to highlight essential components required by the present invention. For instance, service provider server 502 may include alternate memory storage devices such as flash drives, magnetic cassettes, Digital Versatile Disks (DVDs), Bernoulli cartridges, and the like. These and other variations are intended to be within the spirit and scope of the present invention.

Note further that, in a preferred embodiment of the present invention, service provider server 502 performs all of the functions associated with the present invention (including execution of TBFM 448), thus freeing client computer 402 from using its resources.

Note that service provider server 502 may be a WebSphere® server that is under the control of a WebSphere® administrator, while client computer 402 is a user of the WebSphere® services provided by the WebSphere® server. Alternatively, client computer 402 may be a WebSphere® server, while service provider server 502 is another server that “hyper-manages” the functionality of the WebSphere® server.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Software Deployment

As described above, in one embodiment, the processes described by the present invention, including the functions of TBFM 448, are performed by service provider server 502. Alternatively, TBFM 448 and the method described herein, and in particular as shown and described in FIGS. 1-3, can be deployed as a process software from service provider server 502 to client computer 402. Still more particularly, process software for the method so described may be deployed to service provider server 502 by another service provider server (not shown).

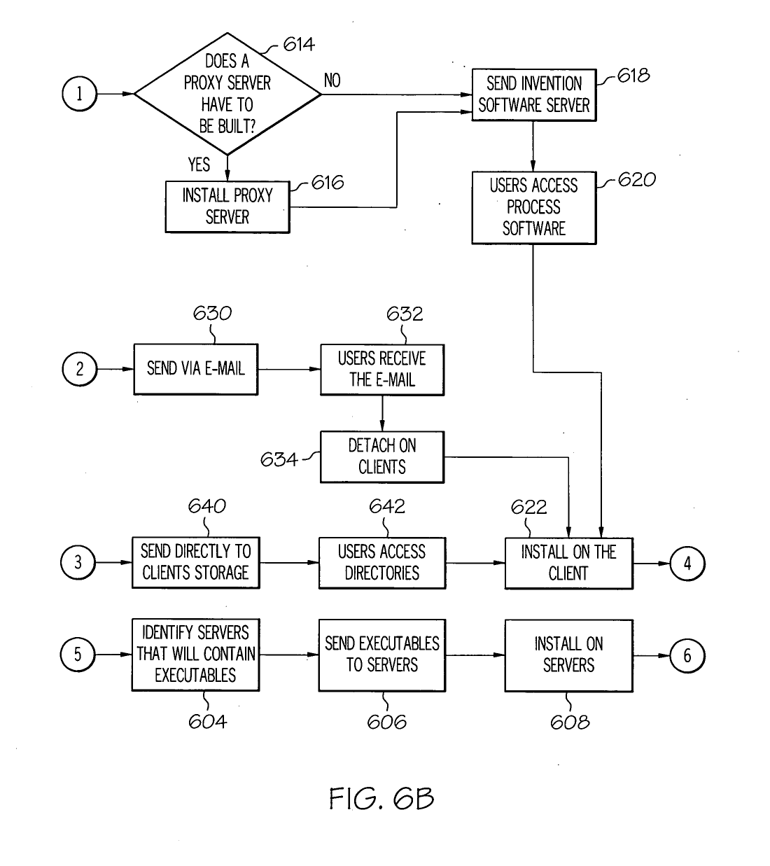

Referring then to FIG. 6, step 600 begins the deployment of the process software. The first thing is to determine if there are any programs that will reside on a server or servers when the process software is executed (query block 602). If this is the case, then the servers that will contain the executables are identified (block 604). The process software for the server or servers is transferred directly to the servers' storage via File Transfer Protocol (FTP) or some other protocol or by copying though the use of a shared file system (block 606). The process software is then installed on the servers (block 608).

Next, a determination is made on whether the process software is to be deployed by having users access the process software on a server or servers (query block 610). If the users are to access the process software on servers, then the server addresses that will store the process software are identified (block 612).

A determination is made if a proxy server is to be built (query block 614) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 616). The process software is sent to the servers either via a protocol such as FTP or it is copied directly from the source files to the server files via file sharing (block 618). Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems (block 620). Another embodiment is to have the servers automatically copy the process software to each client and then run the installation program for the process software at each client computer. The user executes the program that installs the process software on his client computer (block 622) then exits the process (terminator block 624).

In query step 626, a determination is made whether the process software is to be deployed by sending the process software to users via e-mail. The set of users where the process software will be deployed are identified together with the addresses of the user client computers (block 628). The process software is sent via e-mail to each of the users' client computers (block 630). The users then receive the e-mail (block 632) and then detach the process software from the e-mail to a directory on their client computers (block 634). The user executes the program that installs the process software on his client computer (block 622) then exits the process (terminator block 624).

Lastly a determination is made on whether to the process software will be sent directly to user directories on their client computers (query block 636). If so, the user directories are identified (block 638). The process software is transferred directly to the user's client computer directory (block 640). This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software (block 642). The user executes the program that installs the process software on his client computer (block 622) and then exits the process (terminator block 624).

VPN Deployment

The present software can be deployed to third parties as part of a service wherein a third party VPN service is offered as a secure deployment vehicle or wherein a VPN is build on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-bee number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a companies multiple fixed sites over a public network such as the Internet.

The process software is transported over the VPN via tunneling which is the process the of placing an entire packet within another packet and sending it over a network. The protocol of the outer packet is understood by the network and both points, called runnel interfaces, where the packet enters and exits the network.

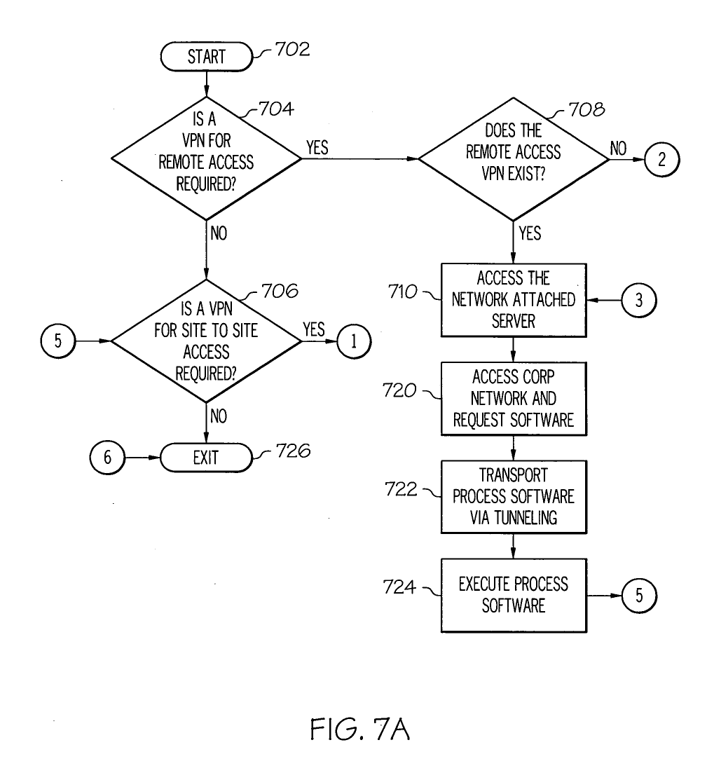

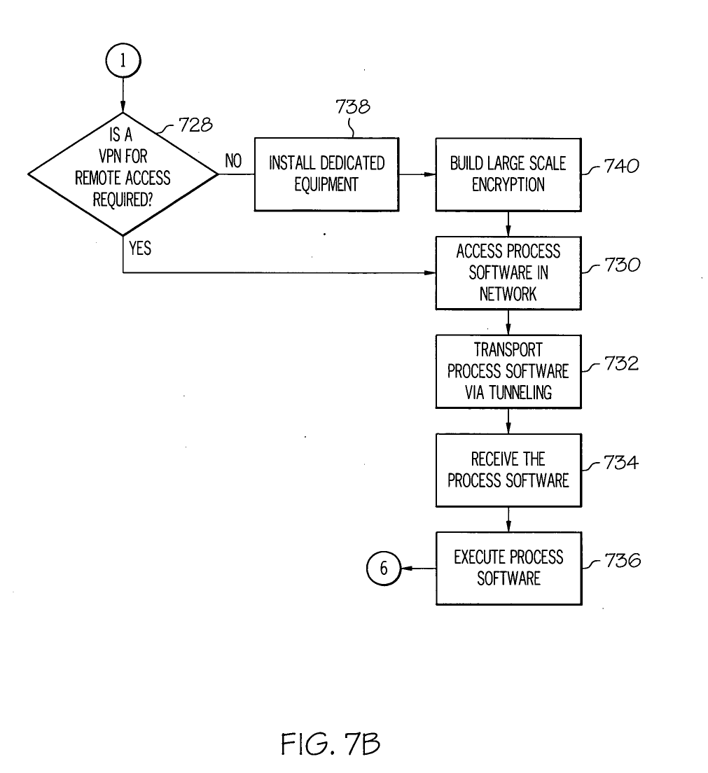

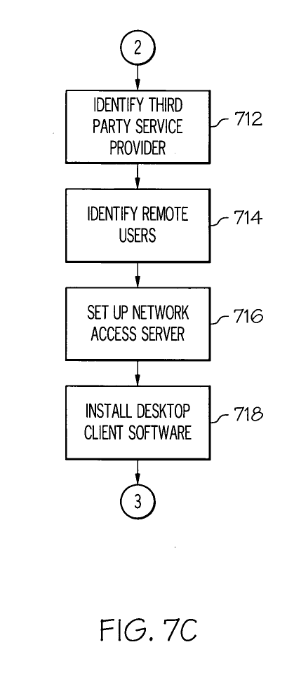

The process for such VPN deployment is described in FIG. 7. Initiator block 702 begins the Virtual Private Network (VPN) process. A determination is made to see if a VPN for remote access is required (query block 704). If it is not required, then proceed to (query block 706). If it is required, then determine if the remote access VPN exists (query block 708).

If a VPN does exist, then proceed to block 710. Otherwise identify a third party provider that will provide the secure, encrypted connections between the company's private network and the company's remote users (block 712). The company's remote users are identified (block 714). The third party provider then sets up a network access server (NAS) (block 716) that allows the remote users to dial a toll free number or attach directly via a broadband modem to access, download and install the desktop client software for the remote-access VPN (block 718).

After the remote access VPN has been built or if it been previously installed, the remote users can access the process software by dialing into the NAS or attaching directly via a cable or DSL modem into the NAS (block 710). This allows entry into the corporate network where the process software is accessed (block 720). The process software is transported to the remote user's desktop over the network via tunneling. That is the process software is divided into packets and each packet including the data and protocol is placed within another packet (block 722). When the process software arrives at the remote user's desk-top, it is removed from the packets, reconstituted and then is executed on the remote users desk-top (block 724).

A determination is then made to see if a VPN for site to site access is required (query block 706). If it is not required, then proceed to exit the process (terminator block 726). Otherwise, determine if the site to site VPN exists (query block 728). If it does exist, then proceed to block 730. Otherwise, install the dedicated equipment required to establish a site to site VPN (block 738). Then build the large scale encryption into the VPN (block 740).

After the site to site VPN has been built or if it had been previously established, the users access the process software via the VPN (block 730). The process software is transported to the site users over the network via tunneling (block 732). That is the process software is divided into packets and each packet including the data and protocol is placed within another packet (block 734). When the process software arrives at the remote user's desktop, it is removed from the packets, reconstituted and is executed on the site users desk-top (block 736). The process then ends at terminator block 726.

Software Integration

The process software which consists code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

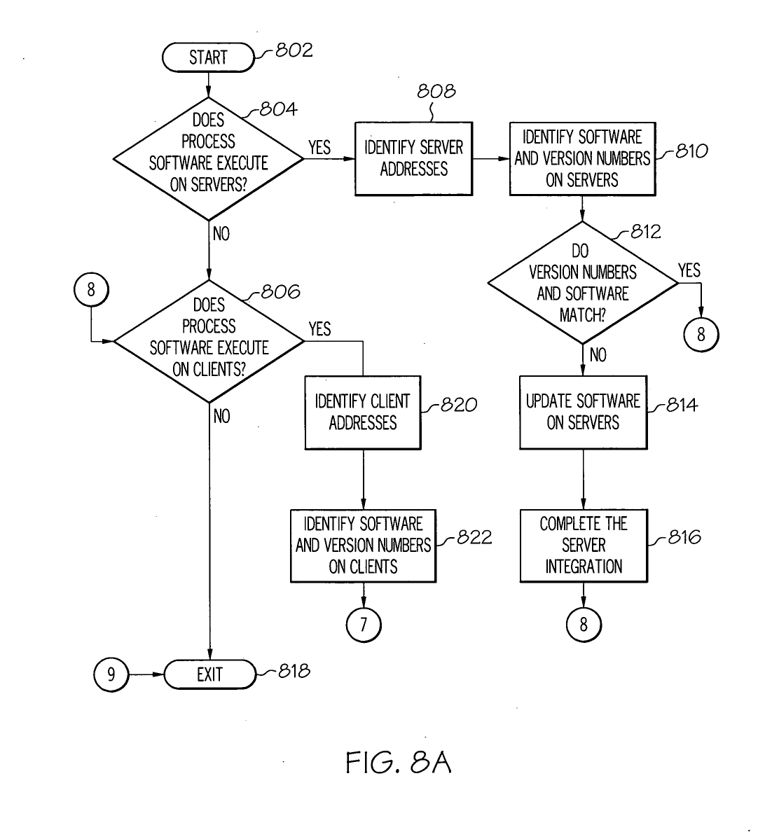

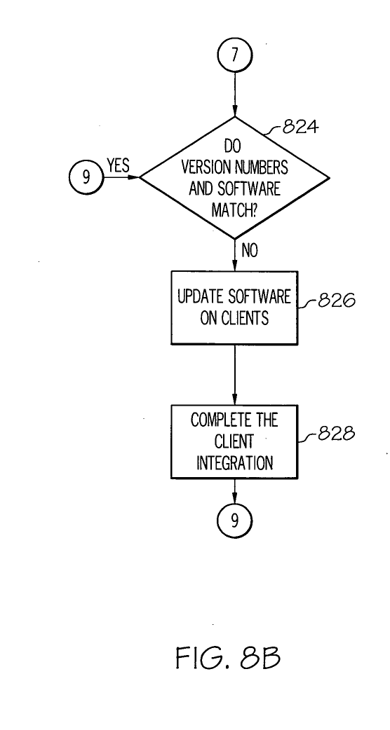

For a high-level description of this process, reference is now made to FIG. 8. Initiator block 802 begins the integration of the process software. The first tiling is to determine if there are any process software programs that will execute on a server or servers (block 804). If this is not the case, then integration proceeds to query block 806. If this is the case, then the server addresses are identified (block 808). The servers are checked to see if they contain software that includes the operating system (OS), applications, and network operating systems (NOS), together with their version numbers, which have been tested with the process software (block 810). The servers are also checked to determine if there is any missing software that is required by the process software in block 810.

A determination is made if the version numbers match the version numbers of OS, applications and NOS that have been tested with the process software (block 812). If all of the versions match and there is no missing required software the integration continues in query block 806.

If one or more of the version numbers do not match, then the unmatched versions are updated on the server or servers with the correct versions (block 814). Additionally, if there is missing required software, then it is updated on the server or servers in the step shown in block 814. The server integration is completed by installing the process software (block 816).

The step shown in query block 806, which follows either the steps shown in block 804, 812 or 816 determines if there are any programs of the process software that will execute on the clients. If no process software programs execute on the clients the integration proceeds to terminator block 818 and exits. If this not the case, then the client addresses are identified as shown in block 820.

The clients are checked to see if they contain software that includes the operating system (OS), applications, and network operating systems (NOS), together with their version numbers, which have been tested with the process software (block 822). The clients are also checked to determine if there is any missing software that is required by the process software in the step described by block 822.

A determination is made is the version numbers match the version numbers of OS, applications and NOS that have been tested with the process software (query block 824). If all of the versions match and there is no missing required software, then the integration proceeds to terminator block 818 and exits.

If one or more of the version numbers do not match, then the unmatched versions are updated on the clients with the correct versions (block 826). In addition, if there is missing required software then it is updated on the clients (also block 826). The client integration is completed by installing the process software on the clients (block 828). The integration proceeds to terminator block 818 and exits.

On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

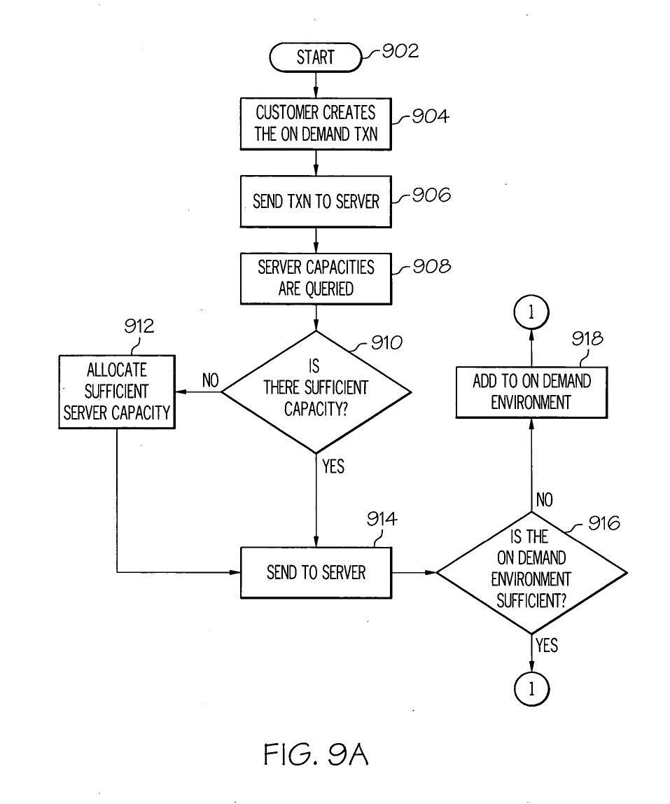

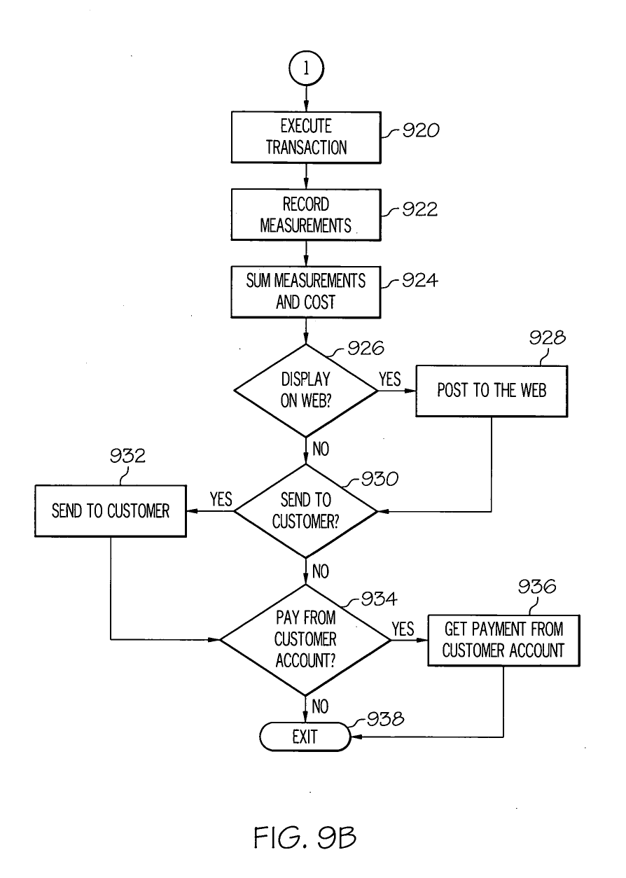

With reference now to FIG. 9, initiator block 902 begins the On Demand process. A transaction is created than contains the unique customer identification, the requested service type and any service parameters that further, specify the type of service (block 904). The transaction is then sent to the main server (block 906). In an On Demand environment the main server can initially be the only server, then as capacity is consumed other servers are added to the On Demand environment.

The server central processing unit (CPU) capacities in the On Demand environment are queried (block 908). The CPU requirement of the transaction is estimated, then the servers available CPU capacity in the On Demand environment are compared to the transaction CPU requirement to see if there is sufficient CPU available capacity in any server to process the transaction (query block 910). If there is not sufficient server CPU available capacity, then additional server CPU capacity is allocated to process the transaction (block 912). If there was already sufficient Available CPU capacity then the transaction is sent to a selected server (block 914).

Before executing the transaction, a check is made of the remaining On Demand environment to determine if the environment has sufficient available capacity for processing the transaction. This environment capacity consists of such things as but not limited to network bandwidth, processor memory, storage etc. (block 916). If there is not sufficient available capacity, then capacity will be added to the On Demand environment (block 918). Next the required software to process the transaction is accessed, loaded into memory, then the transaction is executed (block 920).

The usage measurements are recorded (block 922). The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 924).

If the customer has requested that the On Demand costs be posted to a web site (query block 926), then they are posted (block 928). If the customer has requested that the On Demand costs be sent via e-mail to a customer address (query block 930), then these costs are sent to the customer (block 932). If the customer has requested that the On Demand costs be paid directly from a customer account (query block 934), then payment is received directly from the customer account (block 936). The On Demand process is then exited at terminator block 938.

The present invention thus provides for a method that includes the steps of appending a first timestamp to a first software file that is located in a client system, wherein the first timestamp indicates when the first software file was last modified; and comparing the first timestamp with a latest authorized first timestamp for the first software file. The method may further include the step of enabling a utilization of the first software file only if the first timestamp is identical to the latest authorized first timestamp wherein the latest authorized first timestamp is appended to the first software file by a software administrator, and wherein the first authorized first timestamp is appended to the first software file by a client of the software administrator, and the first timestamp indicates when the first software file was initially installed on the client's system. The method may further include the steps of appending a second timestamp to a second software file that is located in the client's system, wherein the second timestamp indicates when the second software file was last modified, comparing the second timestamp with a latest authorized second timestamp for the second software file, appending a third timestamp to a third software file that is located in the client's system, wherein the third timestamp indicates when the third software file was last modified; and comparing the third timestamp with a latest authorized third timestamp for the third software file. In the scenario in which the first software file is an application file, the second software file is a configuration file, and the third software file is a library file, and wherein the application file is provided by an application infrastructure provider, and wherein the configuration file describes how an application infrastructure is configured for a client system's, and wherein the library file describes applications that are part of the application infrastructure, and wherein the first, second and third software files have their respective time stamps appended thereto, the method further includes the steps of appending the latest authorized first timestamp to a copy of the application file located in an application server that is administered by the software administrator; hashing the copy of the application file located in an application server to create an administrator's hashed application file; appending the latest authorized second timestamp to a copy of the configuration file located in an application server that is administered by the software administrator; hashing the copy of the configuration file located in an application server to create an administrator's hashed configuration file; appending the latest authorized third timestamp to a copy of the library file located in an application server that is administered by the software administrator; hashing the copy of the library file located in an application server to create an administrator's hashed library file; hashing the application file in the client systems to create a client system's hashed application file; hashing the configuration file in the client systems to create a client system's hashed configuration file; hashing the library file in the client system's to create a client system's hashed library file; comparing the client system's hashed application file with the administrator's hashed application file; comparing the client system's hashed configuration file with the administrator's hashed configuration file; and comparing the client system's hashed library file with the administrator's hashed library file. The method can further include the steps of, in response to the client system's hashed application file not matching the administrator's hashed application file, issuing an alert to the software administrator that an unauthorized change to an application file in the client system's has occurred; in response to the client system's hashed configuration file not matching the administrator's hashed configuration file, issuing an alert to the software administrator that an unauthorized change to the configuration file has occurred; and in response to the client system's hashed library file not matching the administrator's hashed library file, issuing an alert to the software administrator that an unauthorized change to the library file has occurred.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A computer-implementable method comprising:
appending a first timestamp to a first software file that is located in a client system, wherein the first timestamp indicates when the first software file was last modified; and
comparing the first timestamp with a latest authorized first timestamp for the first software file.

2. The computer-implementable method of claim 1, further comprising:
enabling a utilization of the first software file only if the first timestamp is identical to the latest authorized first timestamp.

3. The computer-implementable method of claim 2, wherein the latest authorized first timestamp is appended to the first software file by a software administrator, and wherein the first authorized first timestamp is appended to the first software file by a client of the software administrator.

4. The computer-implementable method of claim 1, wherein the first timestamp indicates when the first software file was initially installed on the client's system.

5. The computer-implementable method of claim 1, further comprising:
appending a second timestamp to a second software file that is located in the client's system, wherein the second timestamp indicates when the second software file was last modified; and
comparing the second timestamp with a latest authorized second timestamp for the second software file.

6. The computer-implementable method of claim 5, further comprising:
appending a third timestamp to a third software file that is located in the client's system, wherein the third timestamp indicates when the third software file was last modified; and
comparing the third timestamp with a latest authorized third timestamp for the third software file.

7. The computer-implementable method of claim 6, wherein the first software file is an application file, the second software file is a configuration file, and the third software file is a library file, and wherein the application file is provided by an application infrastructure provider, and wherein the configuration file describes how an application infrastructure is configured for a client system's, and wherein the library file describes applications that are part of the application infrastructure.

8. The computer-implementable method of claim 7, wherein the first, second and third software files have their respective time stamps appended thereto, the computer-implementable method further comprising:
appending the latest authorized first timestamp to a copy of the application file located in an application server that is administered by the software administrator;
hashing the copy of the application file located in an application server to create an administrator's hashed application file;
appending the latest authorized second timestamp to a copy of the configuration file located in an application server that is administered by the software administrator;
hashing the copy of the configuration file located in an application server to create an administrator's hashed configuration file;
appending the latest authorized third timestamp to a copy of the library file located in an application server that is administered by the software administrator;
hashing the copy of the library file located in an application server to create an administrator's hashed library file;
hashing the application file in the client systems to create a client system's hashed application file;
hashing the configuration file in the client systems to create a client system's hashed configuration file;
hashing the library file in the client system's to create a client system's hashed library file;
comparing the client system's hashed application file with the administrator's hashed application file;
comparing the client system's hashed configuration file with the administrator's hashed configuration file; and
comparing the client system's hashed library file with the administrator's hashed library file.

9. The computer-implementable method of claim 8, further comprising:
in response to the client system's hashed application file not matching the administrator's hashed application file, issuing an alert to the software administrator that an unauthorized change to an application file in the client system's has occurred.

10. The computer-implementable method of claim 8, further comprising:
in response to the client system's hashed configuration file not matching the administrator's hashed configuration file, issuing an alert to the software administrator that an unauthorized change to the configuration file has occurred.

11. The computer-implementable method of claim 8, further comprising:
in response to the client system's hashed library file not matching the administrator's hashed library file, issuing an alert to the software administrator that an unauthorized change to the library file has occurred.

12. A system comprising:
a processor;
a data bus coupled to the processor;
a memory coupled to the data bus; and
a computer-usable medium embodying computer program code, the computer program code comprising instructions executable by the processor and configured for:
appending a first timestamp to a first software file that is located in a client system, wherein the first timestamp indicates when the first software file was last modified; and
comparing the first timestamp with a latest authorized first timestamp for the first software file.

13. The system of claim 12, wherein the instructions are further configured for:
enabling a utilization of the first software file only if the first timestamp is identical to the latest authorized first timestamp.

14. A computer-usable medium embodying computer program code, the computer program code comprising computer executable instructions configured for:
appending a first timestamp to a first software file that is located in a client system, wherein the first timestamp indicates when the first software file was last modified; and
comparing the first timestamp with a latest authorized first timestamp for the first software file.

15. The computer-usable medium of claim 14, wherein the computer executable instructions are further configured for:
enabling a utilization of the first software file only if the first timestamp is identical to the latest authorized first timestamp.

16. The computer-usable medium of claim 14, wherein the computer executable instructions are further configured for:
appending a third timestamp to a third software file that is located in the client's system, wherein the third timestamp indicates when the third software file was last modified; and
comparing the third timestamp with a latest authorized third timestamp for the third software file.

17. The computer-usable medium of claim 16, wherein the first software file is an application file, the second software file is a configuration file, and the third software file is a library file, and wherein the application file is provided by an application infrastructure provider, and wherein the configuration file describes how an application infrastructure is configured for a client system's, and wherein the library file describes applications that are part of the application infrastructure.

18. The computer-usable medium of claim 14, wherein the first, second and third software files have their respective time stamps appended thereto, and wherein the computer executable instructions are further configured for:
appending the latest authorized first timestamp to a copy of the application file located in an application server that is administered by the software administrator;
hashing the copy of the application file located in an application server to create an administrator's hashed application file;
appending the latest authorized second timestamp to a copy of the configuration file located in an application server that is administered by the software administrator;
hashing the copy of the configuration file located in an application server to create an administrator's hashed configuration file;
appending the latest authorized third timestamp to a copy of the library file located in an application server that is administered by the software administrator;
hashing the copy of the library file located in an application server to create an administrator's hashed library file;
hashing the application file in the client systems to create a client system's hashed application file;
hashing the configuration file in the client systems to create a client system's hashed configuration file;
hashing the library file in the client system's to create a client system's hashed library file;
comparing the client system's hashed application file with the administrator's hashed application file;
comparing the client system's hashed configuration file with the administrator's hashed configuration file; and
comparing the client system's hashed library file with the administrator's hashed library file.

19. The computer-useable medium of claim 14, wherein the computer executable instructions are deployable to a client computer from a server at a remote location.

20. The computer-useable medium of claim 14, wherein the computer executable instructions are provided by a service provider to a customer on an on-demand basis.
